(19) United States
(12) Patent Application Publication
(10) Pub. No.: US 2005/0274730 A1
(43) Pub. Date: Dec. 15, 2005

(54) Apparatus for reducing loss in a vending machine due to forced entry and vandalism at the door hinge location

(75) Inventors: Calin V. Roatis, Long Grove, IL (US); Richard Paeth, St. Charles, IL (US); Catalin Captarencu, Wheeling, IL (US); Gary L. Myers, Monee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, L.L.C., Elk Grove, IL (US)

(21) Appl. No.: 11/103,328

(22) Filed: Apr. 11, 2005

Related U.S. Application Data
(60) Provisional application No. 60/521,655, filed on Jun. 12, 2004.

(51) Int. Cl. G07F 9/10; G07F 1/04; G07F 11/12; B65H 3/00; B65G 59/00

(52) U.S. Cl. 221/103; 194/350

(57) ABSTRACT

An apparatus is disclosed for use with a vending machine or the like having a cabinet for containing product to be dispensed, and a door for closing the cabinet. The door is hinged at one side with a hinge pin and socket at least at the lower corner. A protective plate fastens to the machine at the lower corner adjacent the hinge and protects against prying the door open at the hinge location.

### RELATED APPLICATIONS

This application claims the benefit of U.S. Provisional Patent Application Ser. No. 60/521,655, filed Apr. 11, 2004, and herein incorporated by reference. This application is also related to U.S. Pat. No. D487,777, and U.S. Design application Ser. No. ______ filed ______, herein incorporated reference.

### FIELD OF THE INVENTION

The present invention relates to the improved construction of a vending machine and, in particular, to devices for reducing loss due to theft and vandalism to such vending machines.

### FEDERALLY SPONSORED RESEARCH OR DEVELOPMENT

None.

### BACKGROUND OF THE INVENTION

The vending industry has been besieged with an ongoing issue of vandalism and break-ins. Vandalism and break-ins result in the loss of currency stored in the machines, costs for fixing the machines, and sales losses while the machines are inoperable due to damage.

One common style of vending machine in use over the years generally includes a door that is hinged at one side. Typically, there is a lower hinge pin that is received in a channel hole and an upper hinge pin that is held by straps at the top of the machine cabinet.

There are many security devices in the marketplace today that have incrementally improved security of specific areas of the vending column. These devices are designed to thwart attempts to gain access to the vending machines through external attacks. An external attack is being defined as a method using any other device other than what was intended to gain access to the inside of the vending machine. Examples of this type of attack are: prying the door with a crowbar, drilling or sawing through door lock and latch components, hammering in vulnerable panels and attached equipment such as the dollar bill validator and the product select buttons of the vending machine. These attacks are typically focused on the column area of the vending machine because the money and the locking system are housed inside the column.

The unique invention disclosed herein provides a solution for a type of common external vending machine vandalism attack, which is directed at prying open the door at the lower hinge side of the door.

### SUMMARY OF INVENTION

The present invention is directed to a security device that can be integrated as part of the original equipment manufacture (OEM) of the vending machine or can be employed as an after-market enhancement to a vending machine. These OEM or after-market devices or vending machines, include a cabinet for containing product to be dispensed, along with a door for closing the cabinet. The door has upper and lower hinge pins about which the door pivots for opening and closing.

According to one aspect of the invention, a protective plate is secured to the side of the machine cabinet adjacent the lower hinged side of the door.

According to another aspect of the invention, the plate is provided with a pin member that aligns with an opening slot in the door. The plate restricts access by a pry bar and the pin on the plate restricts lifting the door out of the hinge pin opening.

According to another aspect of the invention, the plate has an angled side wall that seems to direct tools away from attack points and redistribute pry forces.

According to another aspect of the invention, the plate is made to present an angled edge which deflects forces applied by a prying tool when the tool is inserted between the open edge and edges of the door or cabinet when closed together. In a specific preferred embodiment, the open edge forms one leg of a triangle.

Other embodiments, systems, methods, features, and advantages of the present invention will be, or will become, apparent to one having ordinary skill in the art upon examination of the following drawings and detailed description. It is intended that all such additional systems, methods, features, and advantages included within this description be within the scope of the present invention, and be protected by the accompanying claims.

### DESCRIPTION OF THE DRAWINGS

The invention may be better understood with reference to the following drawings. The components in the drawings are not necessarily to scale, emphasis instead being placed upon illustrating the principles of the invention. In the drawings, like reference numerals designate corresponding parts throughout the several views.

FIG. 1 is an exploded perspective view of a lower corner of a vending machine having a protective plate for attachment thereto in accordance with the present invention;

FIG. 2 is a partial perspective view of a lower corner of the vending machine of FIG. 1 with the protective plate attached thereto and the hinged door partially opened; and

FIG. 3 is a partial perspective view of a lower corner of the vending machine of FIG. 1 with the protective plate attached thereto and the door closed.

### DESCRIPTION OF DETAILED EMBODIMENTS

The following descriptions of detailed embodiments are for exemplifying the principles and advantages of the inventions claimed herein. They are not to be taken in any way as limitations on the scope of the inventions.

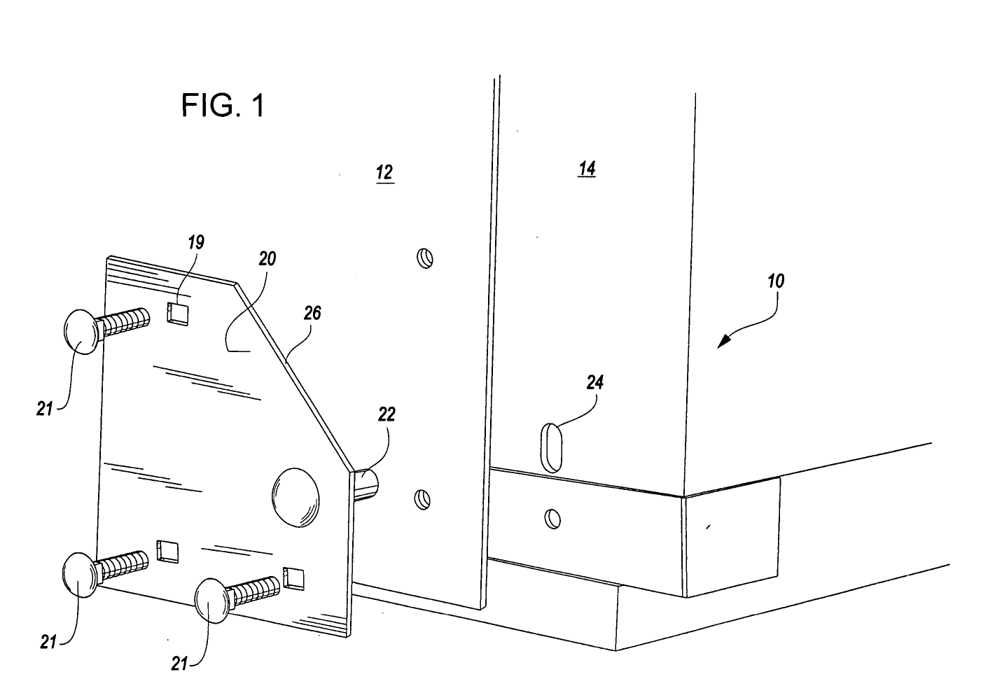

FIG. 1 discloses a lower corner of vending machine 10 having a cabinet 12 for containing product(s) to be dispensed. A door 14 is provided for closing the cabinet 12.

The door has a hinge pin 16, that enters an opening in a channel 18 attached to the machine frame. Thus, the door can swing or pivot with the pin for opening and closing.

In accordance with the present invention, a protective plate 20 having carriage bolt openings 19 receives bolts 21 to secure the plate to the lower side. Other fasteners like screws or rivets may be used. The corner plate also carries a pin 22 that extends into a slot 24 in the edge of the door 14 to frustrate leverage for prying tools and redistribute forces from a prying tool.

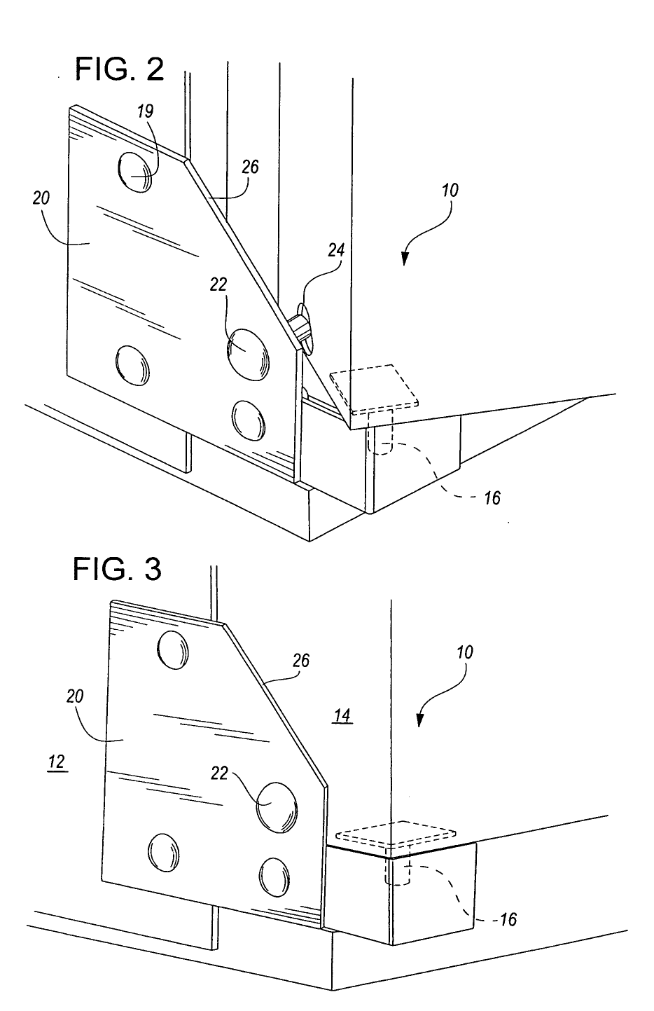

As best shown in FIGS. 2 and 3, the plate 20 presents an edge 26 which deflects forces applied by or to a prying tool when such a tool is attempted to be inserted between the open edges of the door with cabinet. In this case, the edge 26 is angled or forms one leg of a triangle which is not perpendicular to or in parallel with edges of the door 14 where a prying tool can be used. Other surfaces or open edge shapes could provide advantages according to the invention, for example, curved or irregular shapes that are not straight can be used.

It should be emphasized that the above-described embodiment of the present invention, particularly, any “preferred” embodiments, are possible examples of implementations merely set forth for a clear understanding of the principles of the invention. Many variations and modification may be made to the above-described embodiment(s) of the invention without substantially departing from the spirit and principles of the invention. All such modifications are intended to be included herein within the scope of this disclosure and the present invention, and protected by the following claims.

1. In a vending machine or the like having a cabinet for containing products to be dispensed, and a door for closing the cabinet, the door being hinged at one side for opening and closing the door, the hinge being a pin socket type at least at the lower corner of the hinge side of the door, the combination comprising a protective plate attached to the side of the machine adjacent the lower corner, said plate being secured to the machine by fasters and covering the lower hinge corner and edges between the door and cabinet, a pin carried by said plate projecting inwardly toward the door side edge, and a slot formed in the door edge receiving said pin when the door side is closed.

2. A protective plate as claimed in claim 1, wherein the plate presents an edge that deflects force applied by a prying tool applied between open edges of the door and cabinet.

3. A protective plate as claimed in claim 2, wherein said plate edge is angled.

4. A protective plate as claimed in claim 2, wherein said plate edge forms one leg of a triangle and non-parallel and non-perpendicular to edges of the door and cabinet.
